(19) United States
(12) Patent Application Publication
(10) Pub. No.: US 2020/0231103 A1
(43) Pub. Date: Jul. 23, 2020

(54) GROMMET

(71) Applicant: Sumitomo Wiring Systems, Ltd., Mie (JP)

(72) Inventor: Ryota Mori, Mie (JP)

(21) Appl. No.: 16/739,318

(22) Filed: Jan. 10, 2020

(30) Foreign Application Priority Data
Jan. 18, 2019 (JP) 2019-006975

(51) Int. Cl. B60R 16/02

(52) U.S. Cl. CPC B60R 16/0222

(57) ABSTRACT

Provided is a grommet with which it is possible to improve the waterproofing of an automotive body panel. seal-lip 22, before a grommet is attached to an automotive body panel P, has a tapered shape that inclines further away from a first covering portion 31 as it approaches an outer circumferential side, and after the grommet is attached to the automotive body panel P, is configured to bend toward the first covering portion 31 side by abutting the automotive body panel P. Thus, the seal-lip 22 includes a thick portion 41 that is thicker than other parts of the seal-lip 22, and is configured to be sandwiched by the automotive body panel P and the first covering portion 31 as the base portion when the grommet 10 is attached.

### CROSS-REFERENCE TO RELATED APPLICATIONS

This application is based on and claims priority from Japanese Patent Application No. 2019-006975, filed on Jan. 18, 2019, with the Japan Patent Office, the disclosure of which is incorporated herein in their entireties by reference.

### TECHNICAL FIELD

The present invention relates to a waterproofing structure of a grommet that is configured to be fitted into an automotive body panel of an automobile.

### BACKGROUND

Conventional grommets, such as the grommet disclosed in JP 2011-116176A, are fitted into through-holes that are provided in automotive body panels that separate the inside and outside of vehicles, and protect wires that pass through said through-holes. These grommets include waterproofing structures to ensure waterproofing between the inner and outer sides of the automotive body panels. With the grommet in JP 2011-116176A for example, waterproofing is ensured between the grommet and the automotive body panel by bringing a skirt-shaped seal-lip, which is made from a highly bendable material such as elastomer, into areal contact with the area around the through-hole on one side surface (the outer side surface, for example) of the automotive body panel.

### SUMMARY

With the grommet described above, waterproofing between the seal-lip and the automotive body panel is ensured by the strength of areal contact between the seal-lip and the automotive body panel resulting from the elasticity of the seal-lip, and therefore there is a risk of waterproofing no longer being ensured if the strength of areal contact between the seal-lip and the automotive body panel is insufficient and the seal-lip rises.

The present embodiment was made in order to resolve the problems described above, and an object thereof is to provide a grommet with which it is possible to improve the waterproofing of the automotive body panel.

A grommet that solves the above problem is configured to be attached to a through-hole provided in an automotive body panel and to protect a wire harness that is to be passed through the through-hole, the grommet comprising: an annular base portion that faces the area around the through-hole on one side surface of the automotive body panel; and an annular seal-lip that extends from the base portion towards the automotive body panel and is configured to be in areal contact with the area around the through-hole on one side surface of the automotive body panel, wherein the seal-lip, before the grommet is attached to the automotive body panel, has a tapered shape that inclines further away from the base portion as it approaches an outer peripheral side, and after the grommet is attached to the automotive body panel, is configured to bend toward the base portion by abutting the automotive body panel, and the seal-lip includes a thick portion that is thicker than other parts of the seal-lip, and is configured to be sandwiched by the automotive body panel and the base portion when the grommet is attached.

With the mode described above, when the grommet is attached to the automotive body panel, the seal-lip bends towards the base portion by abutting the automotive body panel, and thus the thick portion of the seal-lip is sandwiched and compressed by the base portion and the automotive body panel. It is thus possible to improve the strength of areal contact between the seal-lip and the automotive body panel, and as a result, improve the waterproofing between the seal-lip and the automotive body panel.

Also, if the whole seal-lip is as thick as the thick portion, then the seal-lip will be more rigid, elastic deformation will be difficult, and it will be difficult for the seal-lip to bend towards the base portion. Thus, there is a risk of degrading the attachability of the grommet to the automotive body panel. With the mode described above, a portion of the seal-lip is constituted by a thick portion, and therefore it is possible to improve the waterproofing between the seal-lip and the automotive body panel while suppressing the degradation of the attachability thereof.

In the grommet described above, a protrusion that protrudes toward the seal-lip is provided on a side surface of the base portion facing the seal-lip, and the thick portion is provided at a position abutting the protrusion in a state in which the seal-lip has bent towards the base portion.

With the mode described above, the thick portion of the seal-lip is sandwiched by the protruding portion of the base portion and the automotive body panel when the grommet is attached. Thus, it is possible to suppress the occurrence of the thick portion becoming too thick, and to obtain a desired rate of compression (that is, a desired strength of areal contact of the seal-lip) of the thick portion.

In the grommet described above, a part of an outer side surface of the seal-lip that includes the thick portion has a planar shape that inclines further away from the base portion as it approaches the outer peripheral side, and the thick portion has a shape that protrudes from an inner side surface of the seal-lip.

With the mode described above, a part of the outer side surface of the seal-lip that includes the thick portion has a planar shape before the grommet is attached to the automotive body panel, and the thick portion is made thick due to a portion of the inner side surface of the seal-lip protruding. Therefore, with the shape of the grommet before attachment to the automotive body panel, it is possible to ensure that there is a gap between the outer surface of the seal-lip and the base portion. Thus, it is possible to provide the seal-lip with the thick portion while suppressing the degradation of the moldability of the seal-lip.

With the grommet of the present invention, it is possible to improve waterproofing with of the automotive body panel.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side view of a grommet of an embodiment.

FIG. 2 is a front view of the grommet of the embodiment.

FIG. 3 is a cross-sectional view taken across line 3-3 in FIG. 2.

FIG. 4 is a cross-sectional view of the grommet when attached to the automotive body panel.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

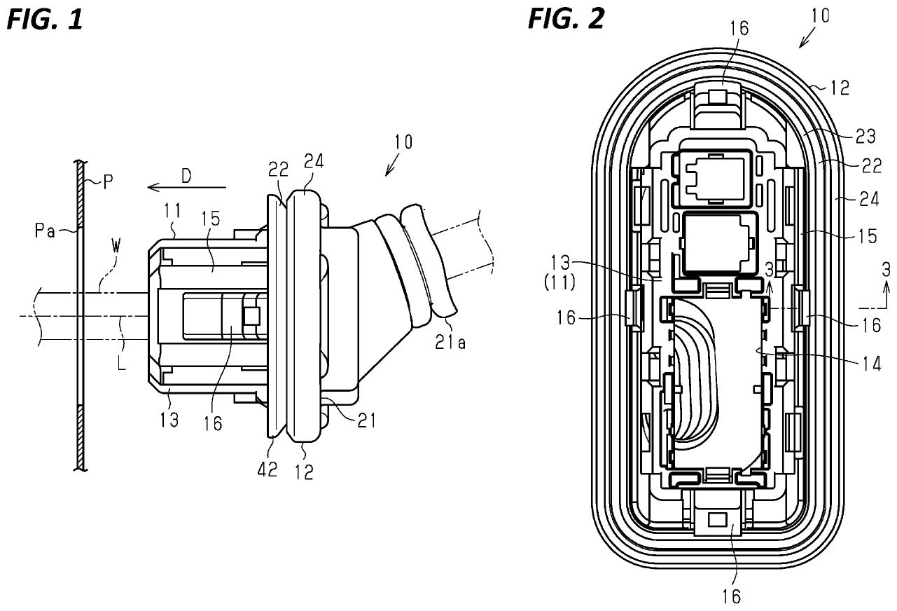

The following is a description of an embodiment of a grommet with reference to the drawings. Note that FIGS. 1 to 3 show the grommet before being attached to the automotive body panel, and FIG. 4 shows the grommet when attached to the automotive body panel.

FIG. 1 shows a grommet 10 of the present embodiment that is to be fitted into a through-hole Pa formed in an automotive body panel P that separates the inside and outside of an automobile, the grommet 10 protecting a wire harness W that is to be passed through said through-hole Pa. The grommet 10 also serves to ensure waterproofing in the through-hole Pa of the automotive body panel P. The wire harness W includes at least one wire. The wire harness W may also include a connector or the like in an internal portion of the grommet 10.

The grommet 10 is provided with an inner member 11 that is inserted into the through-hole Pa of the automotive body panel P, and a sealing member 12 that is attached to the inner member 11. The sealing member 12 is made from a highly bendable material (for example, an elastomer such as EPDM (Ethylene-propylene rubber)). The inner member 11 is made from a material (for example, a synthetic resin such as PP (polypropylene)) with higher rigidity than the sealing member 12.

The inner member 11 includes an insertion portion 13 that is inserted into the through-hole Pa of the automotive body panel P. The insertion portion 13 includes an opening 14 that passes through the insertion portion 13 in the same direction as that of the through-hole Pa when the grommet 10 is attached to the automotive body panel P. The opening 14 brings the inside and outside of a compartment, which is partitioned by the automotive body panel P, into communication with each other when the grommet 10 is attached to the automotive body panel P. The wire harness W is configured to be passed through the opening 14. Note that the opening 14 of the present embodiment is configured such that a connector (not shown) or the like of the wire harness W can be fitted thereto.

As shown in FIGS. 1 and 2, a plurality of locking pieces 16 are provided on an outer peripheral part 15 that surrounds the opening 14 in the insertion portion 13. Note that in the following description, the “radial direction of the inner member 11 (or the insertion portion 13)” refers to the direction that is orthogonal to a center axis line L of the inner member 11 that runs parallel to an insertion direction D of inserting the grommet 10 (inner member 11) into the through-hole Pa of the automotive body panel P. The locking pieces 16 of the present embodiment are respectively provided in four directions (shown as up, down, left, and right in FIG. 2) that are orthogonal to the center axis line L of the inner member 11. The locking pieces 16 are configured to elastically bend in the radial direction of the inner member 11. Also, each locking piece 16 includes a locking protrusion 16a that protrudes outward in the radial direction from the inner member 11. The locking protrusions 16a of the locking pieces 16 are able to lock, in the opposite direction to the insertion direction D, to parts of the peripheral edge of the through-hole Pa that are inside the compartment (see FIG. 4).

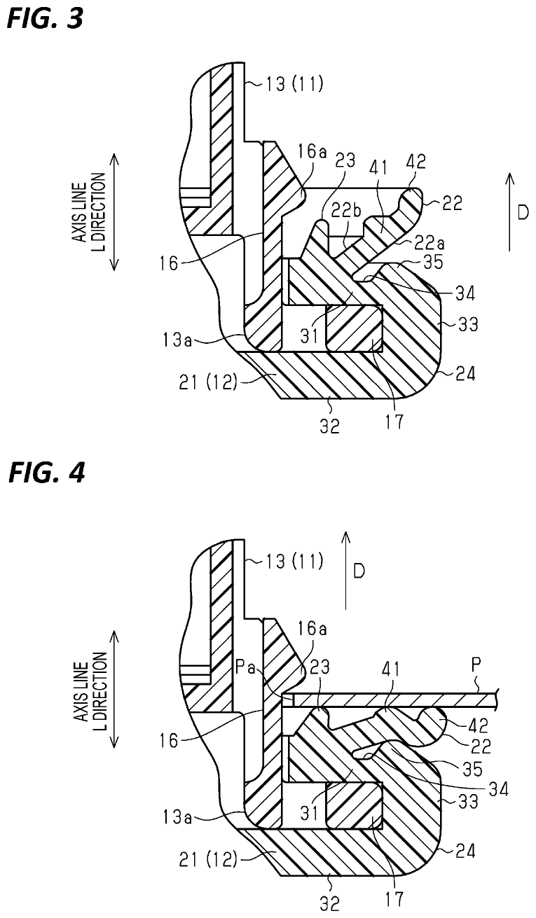

As shown in FIG. 3, the inner member 11 includes a flange portion 17 that extends outward in the radial direction from an end portion 13a (the end portion on the rear side in the insertion direction D) of the insertion portion 13 in the axis line L direction. The flange portion 17 is formed annularly around the whole circumference of the end portion 13a of the insertion portion 13. The flange portion 17 has a flat plank shape that is perpendicular to the center axis line L of the inner member 11, and both side surfaces of the flange portion 17 in the axis line L direction are parallel to the automotive body panel P when the grommet 10 is attached thereto. Also, the outer shape of the flange portion 17 is larger than the through-hole Pa of the automotive body panel P, and the flange portion 17 is positioned on the outer side of the automotive body panel P when the grommet 10 is attached to the automotive body panel P.

As shown in FIGS. 1 to 3, the sealing member 12 is attached to the inner member 11, and the sealing member 12 includes a cover portion 21 that covers the end portion 13a of the insertion portion 13 including the flange portion 17 of the inner member 11, a seal-lip 22 that is formed as a single body with the cover portion 21, and a waterproofing portion 23 that is formed as a single body with the cover portion 21 similarly to the seal-lip 22. Note that the cover portion 21 is formed as a single body with an outer cover portion 21a (see FIG. 1) that has a tubular shape and covers the outer periphery of the wire harness W that is pulled from the insertion portion 13 of the inner member 11 to the outside of the compartment.

As shown in FIGS. 2 and 3, a flange covering portion 24 is formed on the outer peripheral edge of the cover portion 21 and covers the whole circumference of the flange portion 17. The flange covering portion 24 includes first and second covering portions 31 and 32 that respectively cover both side surfaces of the flange covering portion 24 in the axis line L direction, and a third covering portion 33 that connects the outer peripheral edge of the first covering portion 31 and the outer peripheral edge of the second covering portion 32 and covers the outer peripheral surface (the surface of the outer side in the radial direction) of the flange portion 17. The first covering portion 31 covers the side surface of the flange portion 17 that faces the locking pieces 16, which is the side surface of the front side of the flange portion 17 in the insertion direction D. The second covering portion 32 covers the side surface of the flange portion 17 on the opposite side to the side covered by the first covering portion 31, or in other words, covers a side surface of the flange portion 17 on the opposite side to the side that faces the locking pieces 16. Note that the first covering portion 31 of the present embodiment is equivalent to the “base portion” in the claims.

The seal-lip 22 and the waterproofing portion 23 are formed as a single body with the first covering portion 31. The seal-lip 22 has an annular shape and is bigger than the through-hole Pa of the automotive body panel P. Also, the seal-lip 22 has a tapered shape that inclines further away from the first covering portion 31 (inclines to the forward side of the insertion direction D) as it approaches the outer peripheral side (outward in the radial direction). Thus, the seal-lip 22 is in areal contact with the area around the through-hole Pa on the outer side surface of the automotive body panel P when the grommet 10 is attached. Note that before being attached to the automotive body panel P, the outer shape of the seal-lip 22 as viewed from the axis line L direction is smaller than the outer shape of the flange covering portion 24.

An outer side surface 22a of the seal-lip 22 has a planar shape that inclines further away from the first covering portion 31 as it approaches the outer peripheral side (outward in the radial direction). In the first covering portion 31, an inner annular surface 34 that is continuous with a base portion in the outer side surface 22a of the seal-lip 22, and an annular protrusion 35 that is located on the outer peripheral side of the inner annular surface 34 are both formed in the side surface in the axis line L direction that faces the outer side surface 22a of the seal-lip 22. The inner annular surface 34 of the present embodiment has a planar shape that is perpendicular to the axis line L direction (that is, parallel with the flange portion 17). The protrusion 35 is continuous with the outer peripheral side of the inner annular surface 34 and protrudes in the axis line L direction further towards the seal-lip 22 than the inner annular surface 34 does. That is, the side surface of the first covering portion 31 that faces the outer side surface 22a of the seal-lip 22 in the axis line L direction has a shape that bulges toward the seal-lip 22 from the inner annular surface 34 to the protrusion 35.

A thick portion 41 that is thicker than other portions of the seal-lip 22 is formed in a middle portion of the seal-lip 22 in the extending direction (the direction in which the seal-lip 22 inclines relative to the center axis line L). Also, a support seal portion 42 is formed on the outer peripheral edge (opening edge portion) of the seal-lip 22. The support seal 42 is formed due to the outer peripheral edge of the seal-lip 22 curving to the side opposite to the flange covering portion 24 in the axis line L direction. The thick portion 41 and the support seal 42 are formed in an annular shape around the whole circumference of the seal-lip 22. When the grommet 10 is attached and the seal-lip 22 abuts the automotive body panel P and bends toward the first covering portion 31 side, the thick portion 41 abuts the protrusion 35 of the first covering portion 31.

Parts of an inner side surface 22b of the seal-lip 22 other than the thick portion 41 and the support seal 42 have a level planar shape (that is, a planar shape that inclines further away from the first covering portion 31 as it approaches the outer peripheral side (outward in the radial direction)) that is parallel with the outer side surface 22a of the seal-lip 22. Also, the thick portion 41 protrudes from the inner side surface 22b of the seal-lip 22 towards the inner peripheral side (toward the center axis line L) of the seal-lip 22. Thus, the thickness of the thick portion 41 is ensured.

The waterproofing portion 23 is formed at a position that is further radially inward than the seal-lip 22 is. The waterproofing portion 23 protrudes forward in the insertion direction D from the first covering portion 31, and has an annular shape that is bigger than the through-hole Pa of the automotive body panel P. The waterproofing portion 23 is in areal contact with the circumference of the through-hole Pa in the inner side surface of the automotive body panel P when the grommet 10 is attached thereto. Note that with the waterproofing portion 23 and the seal-lip 22, the seal-lip 22 has a higher protrusion height in the axis line L direction.

The following describes the action of the present embodiment.

When the grommet 10 is inserted into the through-hole Pa of the automotive body panel P in the insertion direction D, the seal-lip 22 abuts the automotive body panel P and bends toward the first covering portion 31, as shown in FIG. 4. Then, the thick portion 41 of the seal-lip 22 abuts the protrusion 35 of the first covering portion 31, and the thick portion 41 is therefore sandwiched by the protrusion 35 and the automotive body panel P. As the thick portion 41 and the protrusion 35 are squashed together and are in a compressed state, the strength of areal contact of the seal-lip 22 to the automotive body panel P can thus be improved. Also, at this time, the locking protrusions 16a of the locking pieces 16 of the inner member 11 are locked to the peripheral edge of the through-hole Pa, and therefore the grommet 10 is fixed in the insertion direction D in a state in which the thick portion 41 and the protrusion 35 are compressed.

Also, when the grommet 10 is attached, the waterproofing portion 23 is in areal contact with the automotive body panel P on the inner circumferential side with respect to the thick portion 41, and the support seal 42 is in areal contact with the automotive body panel P on the outer circumferential side with respect to the thick portion 41. Thus, waterproofing between the grommet 10 (the sealing member 12) and the automotive body panel P can be further improved.

The following describes the effect of the present embodiment.

(1) The seal-lip 22 includes a thick portion 41 that is thicker than other parts of the seal-lip 22, and is configured to be sandwiched by the automotive body panel P and the first covering portion 31 as the base portion when the grommet 10 is attached. With the mode described above, when the grommet 10 is attached to the automotive body panel P, the seal-lip 22 bends towards the first covering portion 31 by abutting with the automotive body panel P and the thick portion 41 of the seal-lip 22 is sandwiched and compressed by the first covering portion 31 and the automotive body panel P. The strength of areal contact of the seal-lip 22 to the automotive body panel P can be improved, and as a result the waterproofing can be improved in the automotive body panel P.

Also, if the whole seal-lip 22 is formed with the thickness of the thick portion 41, then the seal-lip 22 will be more rigid, elastic deformation will be difficult, and it will be difficult for the seal-lip 22 to bend towards the first covering portion 31. Thus, there is a risk of degrading the attachability of the grommet 10 to the automotive body panel P. With the mode described above, a portion of the seal-lip 22 is constituted by a thick portion 41 and therefore it is possible to improve the waterproofing in the automotive body panel P while suppressing the degradation of attachability.

(2) The protrusion 35 that protrudes toward the seal-lip 22 is provided on a side surface of the first covering portion 31 facing the seal-lip 22 and protrudes toward the seal-lip 22, and the thick portion 41 is provided at a position abutting the protrusion 35 in a state in which the seal-lip 22 has bent towards the first covering portion 31.

With the mode described above, the thick portion 41 of the seal-lip 22 is sandwiched by the protrusion 35 of the first covering portion 31 and the automotive body panel P when the grommet 10 is attached thereto. Thus, it is possible to suppress the occurrence of the thick portion 41 becoming too thick, and to obtain a desired rate of compression (that is, a desired strength of areal contact of the seal-lip 22) in the thick portion 41.

Also, on the side surface of the first covering portion 31 that faces the seal-lip 22, the inner peripheral side of the protrusion 35 forms a part (the inner annular surface 34) that is lower than the protrusion 35, and therefore it is possible to ensure a gap between the first covering portion 31 and the seal-lip 22, which is the base portion. Note that even when the grommet 10 is attached, that is, even when the seal-lip 22 bends toward the first covering portion 31 and the thick portion 41 abuts the protrusion 35, there is a gap between the seal-lip 22 and the inner annular surface 34.

(3) A part of an outer side surface 22a of the seal-lip 22 that includes the thick portion 41 has a planar shape that inclines further away from the first covering portion 31 as it approaches the outer peripheral side, and the thick portion 41 has a shape that protrudes from an inner side surface 22b of the seal-lip 22.

With the mode described above, a part of the outer side surface 22a of the seal-lip 22 that includes the thick portion 41 has a planar shape before the grommet 10 is attached to the automotive body panel P, and the thick portion 41 is made thick due to a portion of the inner side surface 22b of the seal-lip 22 protruding. Therefore, with the shape of the grommet 10 before attachment to the automotive body panel P, it is possible to ensure a gap between the outer side surface 22a of the seal-lip 22 and the first covering portion 31. Thus, it is possible to provide the seal-lip 22 with the thick portion 41 while suppressing the degradation of the moldability of the grommet 10.

(4) The support seal 42, the thick portion 41, and the waterproofing portion 23 make it possible to, in a stepwise fashion, suppress the occurrence of water entering therein, and it is thus possible to achieve suitable waterproofing. Also, the amount of water that reaches the waterproofing portion 23 is less, and therefore it is possible to reduce the amount that the waterproofing portion 23 is squashed when attached. The amount that the waterproofing portion 23 is squashed has a strong effect on the force with which the grommet 10 is inserted into the through-hole Pa, and therefore reducing the amount that the waterproofing portion 23 is squashed contributes to reducing the force of insertion.

The present embodiment may be altered and implemented in any of the following ways. The present embodiments and the following variations can be combined and implemented provided there are no technical contradictions.

With the embodiments described above, a portion of the inner side surface 22b of the seal-lip 22 protrudes from the inner peripheral surface and therefore ensures the thickness of the thick portion 41, but there is notlimitation thereto and a configuration is also possible in which a portion of the outer side surface 22a of the seal-lip 22 protrudes from the outer peripheral surface and therefore ensures the thick portion 41 of the thick portion 41.

With the embodiments described above, the side surface of the first covering portion 31 that faces the outer side surface 22a of the seal-lip 22 in the axis line L direction has a shape that bulges toward the seal-lip 22 from the inner annular surface 34 to the protrusion 35, but there is no limitation thereto, and for example, a configuration is also possible in which the entirety of the side surface of the first covering portion 31 is formed with the same height as the inner annular surface 34. In this case, by making the thickness of the thick portion 41 of the seal-lip 22 thicker than that of the embodiments described above, it is possible to make the rate of compression (that is, the desired strength of areal contact of the seal-lip 22) of the thick portion 41 that is sandwiched by the first covering portion 31 and the automotive body panel P similar to that of the embodiments described above.

With the embodiments described above, the present invention was applied to a grommet 10 made from the sealing member 12, which is made from a highly bendable material such as elastomer, and the inner member 11, which is more rigid than the sealing member 12, but there is no limitation thereto, and for example the present invention can also be applied to a grommet constituted by only the highly bendable material.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A grommet that is configured to be attached to a through-hole provided in an automotive body panel and to protect a wire harness that is to be passed through the through-hole, the grommet comprising:
an annular base portion that faces the area around the through-hole on one side surface of the automotive body panel; and
an annular seal-lip that extends from the base portion towards the automotive body panel and is configured to be in areal contact with the area around the through-hole on one side surface of the automotive body panel,
wherein the seal-lip, before the grommet is attached to the automotive body panel, has a tapered shape that inclines further away from the base portion as it approaches an outer peripheral side, and after the grommet is attached to the automotive body panel, is configured to bend toward the base portion by abutting the automotive body panel, and
the seal-lip includes a thick portion that is thicker than other parts of the seal-lip, and is configured to be sandwiched by the automotive body panel and the base portion when the grommet is attached.

2. The grommet according to claim 1,
wherein a protrusion that protrudes toward the seal-lip is provided on a side surface of the base portion facing the seal-lip, and
the thick portion is provided at a position abutting the protrusion in a state in which the seal-lip has bent towards the base portion.

3. The grommet according to claim 1,
wherein a part of an outer side surface of the seal-lip that includes the thick portion has a planar shape that inclines further away from the base portion as it approaches the outer peripheral side, and
the thick portion has a shape that protrudes from an inner side surface of the seal-lip.

4. The grommet according to claim 2,
wherein a part of an outer side surface of the seal-lip that includes the thick portion has a planar shape that inclines further away from the base portion as it approaches the outer peripheral side, and
the thick portion has a shape that protrudes from an inner side surface of the seal-lip.
